(19) United States
(12) Patent Application Publication
(10) Pub. No.: US 2008/0187697 A1
(43) Pub. Date: Aug. 7, 2008

(54) Structure and Method for Bonding Two Members, Gas Container and Method for Manufacturing Such Gas Container

(76) Inventor: Masaaki Amano, Aichi (JP)

Correspondence Address: KENYON & KENYON LLP, 1500 K STREET N.W., SUITE 700, WASHINGTON, DC, 20005, US

(21) Appl. No.: 11/883,799

(22) PCT Filed: Feb. 9, 2006
(86) PCT No.: PCT/JP2006/002682

§ 371 Date: Aug. 7, 2007

(30) Foreign Application Priority Data
Mar. 8, 2005 (JP) 2005-064196

(51) Int. Cl. B32B 1/02; B29C 65/16; B32B 1/08

(52) U.S. Cl. 428/35.7; 156/272.8

(57) ABSTRACT

An object is to provide a bonded structure of two members, a bonding method of two members in which end portions of a pair of resin members can appropriately be bonded to each other by laser welding while easily suppressing a positional deviation between the end portions of the resin members, a gas container and a manufacturing method of the gas container. In the bonded structure of two members, an external thread provided at a substantially cylindrical end portion of a resin member is screwed into an internal thread provided at a substantially cylindrical end portion of a resin member and irradiated with laser to bond the end portions of the resin members to each other by the laser welding. In the gas container, this bonded structure is applied to a resin liner of the gas container, and liner constituting members are screwed and bonded by the laser welding.

### TECHNICAL FIELD

The present invention relates to a bonded structure of two members in which substantially cylindrical end portions of a pair of resin members are bonded to each other, and a method of the bonded structure. The present invention also relates to a gas container including a resin liner constituted by bonding a plurality of liner constituting members, more particularly to a gas container in which end portions of the liner constituting members to be bonded have a cylindrical shape. The present invention further relates to a manufacturing method of the gas container.

### BACKGROUND ART

Heretofore, from viewpoints of lightening and the like, pipe-like materials constituting a piping line and the like and an inner shell (a liner) of a gas container are made of a resin to form a molded resin material. Such type of molded resin material is constituted by bonding divided molded materials, which are divided and molded beforehand, to one another in many cases. In this case, as a bonding method, a laser welding method is utilized.

For example, JP 2004-90630 (FIG. 1 and Page 2) discloses a structure in which end portions of a pair of molded pipe materials are bonded to each other by laser welding. In this bonded structure, a tapered bonding surface formed on an outer surface of the end portion of one of the molded pipe materials is allowed to abut on an inverted tapered bonding surface formed on an inner surface of the end portion of the other molded pipe material, and irradiated with laser in this contact state to bond the bonding surfaces to each other by the laser welding.

### DISCLOSURE OF THE INVENTION

Such a conventional bonded structure includes tapered and inverted tapered bonding surfaces. Therefore, the structure is useful in that, for example, even if thin molded pipe materials are bonded to each other, a bonding area between the materials can be increased. However, the structure is irradiated with laser in a state in which both the bonding surfaces are simply allowed to abut on each other. Therefore, there is a possibility that abutment of the bonding surfaces deviates during the irradiation with the laser. In consequence, a bonding defect might be caused.

Needless to say, to solve such a problem of bonding defect, it is considered that a pressurizing jig be prepared for maintaining the contact state between the end portions, but this incurs much cost and additionally becomes complicated.

An object of the present invention is to provide a bonded structure of two members and a bonding method capable of appropriately bonding end portions of a pair of resin members to each other by laser welding in a state in which a positional deviation between the end portions of the resin members is simply suppressed.

Moreover, an object of the present invention is to provide a gas container and a manufacturing method of the gas container capable of appropriately bonding end portions of liner constituting members to each other by laser welding in a state in which this bonded structure of two members is applied to a resin liner of a gas container to suppress a positional deviation between the end portions of the liner constituting members.

To achieve the above object, a bonded structure of two members of the present invention is a bonded structure of two members in which end portions of a pair of resin members having at least substantially cylindrical end portions are engaged with each other by an engagement structure, and the resin members are bonded by laser welding. The engagement structure has an external thread provided at the end portion of one of the resin members; and an internal thread that is provided at the end portion of the other resin member and into which the external thread is screwed.

According to this constitution, the external thread or the internal thread is provided at the substantially cylindrical end portion as a bonded portion between the resin members. Therefore, these mutually screwed threads can be irradiated with laser. In consequence, the resin members can be held so that the end portions of the members come into close contact with each other during the irradiation with the laser. Therefore, the positional deviation between the end portions can preferably be suppressed without using any pressurizing jig or the like. Therefore, the end portions can satisfactorily be bonded to each other by the laser welding. Since a bonded portion subjected to the laser welding is also bonded by tightening the threads, strength of the bonded portion can be improved. Furthermore, when the substantially cylindrical end portions are bonded to each other, centering is usually complicated. However, the centering can easily be performed by a screwed structure between the external thread and the internal thread.

Here, the “resin member having at least substantially cylindrical end portions” includes that the resin member as a whole has a cylindrical shape, an annular shape, a bowl-like shape, a domed shape or the like.

According to one aspect of the above bonded structure of the present invention, it is preferable that an inner peripheral surface of the end portion provided with the internal thread has a sloped bonding surface, an outer peripheral surface of the end portion provided with the external thread has a bonding surface which is matched with the bonding surface to abut on this bonding surface, and the bonding surfaces are bonded to each other by the laser welding.

If the bonding surface is constituted of the sloped surface in this manner, a contact area (a bonding area) between the bonding surfaces can be increased. Moreover, the constitution can be useful in centering the bonding surfaces.

Preferably, the screwed external and internal threads are bonded at the bonding surfaces by the laser welding.

According to this constitution, the bonding area can further be increased. Moreover, sealing property at the bonded portion subjected to the laser welding can be improved.

Preferably, the end portion provided with the internal thread is made of a laser transmitting resin, and the end portion provided with the external thread is made of a laser absorbing resin.

According to this constitution, if the laser transmitting end portion is irradiated with the laser, the laser absorbing end portion is heated and melted.

Moreover, since heat is conducted from the laser absorbing end portion, the laser transmitting end portion is heated and melted. Since a laser transmitting or absorbing property is imparted to the end portion in this manner, the end portions can appropriately be bonded to each other. It is to be noted that this type of property with respect to the laser may be imparted to the only end portions. However, when the property is imparted to the whole resin member including the end portions, the resin member can more easily be manufactured.

Preferably, the external thread and the internal thread are made of a metal material.

According to this constitution, as compared with a case where the external thread and the internal thread are made of the resin, a strong tightening force can be obtained. It is to be noted that the external thread or the internal thread may be provided at the end portion of the resin member with adhesive or the like, or provided at the end portion of the resin member by insertion molding on the resin member.

Preferably, the external thread is a tapered external thread, and the internal thread is a tapered internal thread.

According to this constitution, the tapered threads are connected to each other. Therefore, one of the tapered external thread and the tapered internal thread is crushed, when the external thread is screwed into the internal thread. In consequence, as compared with a case where straight threads are connected to each other, the sealing property at the bonded portion subjected to the laser welding can further be improved.

To achieve the above object, a bonding method of two members of the present invention in which end portions of a pair of resin members having at least substantially cylindrical end portions are bonded to each other has:

irradiating, with laser, an external thread provided at the end portion of one of the resin members and an internal thread provided at the end portion of the other resin member in a state in which the external thread is screwed into the internal thread, thereby bonding the end portions of the resin members to each other by laser welding.

According to this method, the mutually screwed end portions are irradiated with the laser. Therefore, the end portions can satisfactorily be bonded to each other by the laser welding without using any pressurizing jig or the like in a state in which a positional deviation between the end portions is preferably suppressed. The strength of the bonded portion subjected to the laser welding can be improved, and the end portions can easily be centered in the same manner as described above.

Preferably, after screwing the external thread into the internal thread until a bonding surface of the end portion provided with the external thread comes into contact with a bonding surface of the end portion provided with the internal thread, the bonding surfaces are bonded to each other by the laser welding.

In consequence, the external thread is screwed into the internal thread until the bonding surfaces come into contact with each other. Therefore, the bonding surfaces as targets of the laser welding can securely be brought into close contact with each other. In consequence, the bonding surfaces can satisfactorily and securely be subjected to the laser welding.

Preferably, the bonding surfaces are bonded to each other in a circumferential direction by the laser welding.

In consequence, the whole peripheries of the bonding surfaces are linearly welded to each other with the laser.

Preferably, the screwed external and internal threads are bonded at the bonding surfaces by the laser welding. Preferably, the end portion of one resin member is made of a laser transmitting resin, the end portion of the other resin member is made of a laser absorbing resin beforehand, and the laser absorbing end portion is irradiated with the laser from the side of this laser transmitting end portion to bond the bonding surfaces to each other by the laser welding. Preferably, the external thread and the internal thread are made of a metal material. Preferably, the external thread is a tapered external thread, and the internal thread is a tapered internal thread.

To achieve the above object, a gas container of the present invention has a resin liner constituted by bonding a pair of liner constituting members as a pair of resin members to each other by use of the above-mentioned method for bonding two members of the present invention; and a reinforcing layer arranged on an outer periphery of the resin liner.

According to this constitution, since the above-mentioned bonding method is utilized in integrally bonding a pair of liner constituting members to each other, the satisfactorily bonded resin liner can be constituted. Since the gas container includes this resin liner, airtightness, productivity and the like of the gas container can be improved.

To achieve the above-mentioned object, another gas container of the present invention has a resin liner. The resin liner is constituted by bonding a plurality of liner constituting members having at least substantially cylindrical end portions. A bonded portion between the liner constituting members has an engagement structure which engages the substantially cylindrical end portions of the liner constituting members with each other, and a laser welded portion constituted by bonding the substantially cylindrical end portions of the liner constituting members to each other by laser welding. The engagement structure has an external thread at one of the end portions, and an internal thread at the other end portion, the external thread is screwed into the internal thread.

According to this constitution, in a manufacturing process of the resin liner constituted by bonding the liner constituting members to each other, the end portions of the liner constituting members can be engaged with each other by the engagement structure, and irradiated with laser in this engaged state. In consequence, the positional deviation between the end portions can preferably be suppressed without using any pressurizing jig or the like, and the end portions can satisfactorily be bonded to each other by the laser welding. Especially, since the engagement structure is a screwed structure, the end portions can be held so as to come into close contact with each other. Moreover, the centering during the bonding is facilitated. Even after the laser welding, the bonded portion is engaged by the engagement structure in addition to a laser welded portion. Therefore, strength of the bonded portion can be improved.

Here, the laser welded portion is a portion formed by melting a part of the end portion of one of the bonded liner constituting members and a part of the end portion of the other liner constituting member.

Preferably, an inner peripheral surface of the end portion provided with the internal thread has a sloped bonding surface, and an outer peripheral surface of the end portion provided with the external thread has a bonding surface which is matched with the sloped bonding surface to abut on this bonding surface, and the laser welded portion is formed by melting the bonding surfaces.

According to this constitution, the increase of the contact area (the bonding area) between the bonding surfaces and the like can be achieved in the same manner as described above.

Moreover, according to one aspect of the gas container of the present invention described above, in the same manner as in the above-mentioned bonded structure of two members, it is preferable that the end portion provided with the internal thread is made of a laser transmitting resin and that the end portion provided with the external thread is made of a laser absorbing resin. It is also preferable that the external thread and the internal thread are made of a metal material. According to another preferable aspect, the external thread may be formed integrally with the end portion provided with the external thread, and the internal thread may be formed integrally with the end portion provided with the internal thread. Furthermore, it is preferable that the external thread is a tapered external thread and that the internal thread is a tapered internal thread.

Preferably, the outer peripheral surfaces of the liner constituting members are bonded to the same plane.

According to this constitution, for example, a layer such as a reinforcing layer can appropriately be formed on, for example, an outer periphery of a resin liner.

Preferably, the laser welded portion is provided at the resin liner in a circumferential direction.

According to this constitution, the resin liner can be bonded in the circumferential direction.

Preferably, at least one of the plurality of liner constituting members has a communicating portion which is provided on a side opposite to a bonded portion to be bonded to the other liner constituting member and which allows an inner hollow portion of the resin liner to communicate with the outside.

According to this constitution, the inner hollow portion of the resin liner is filled with a gas via the communicating portion, or the gas can be discharged from the inner hollow portion via the communicating portion.

Preferably, the gas container of the present invention is configured to store combustible gas having a high pressure.

Here, the combustible gas is, for example, hydrogen gas or compressed natural gas.

Preferably, the gas container of the present invention further includes a container main body having the resin liner and a reinforcing layer arranged on an outer periphery of the resin liner; and a mouthpiece provided at one end portion of the container main body.

To achieve the above-mentioned object, a manufacturing method of a gas container of the present invention is a manufacturing method of a gas container having a resin liner constituted by bonding a plurality of liner constituting members having at least substantially cylindrical end portions. The method comprises: an engagement step of engaging the substantially cylindrical end portion of one of the liner constituting members to be bonded to each other with the substantially cylindrical end portion of the other liner constituting member; and an irradiation step of irradiating the end portions subjected to the engagement step with laser to bond the end portions to each other by laser welding. The engagement step is performed by screwing an external thread provided at the substantially cylindrical end portion of the one liner constituting member into an internal thread provided at the substantially cylindrical end portion of the other liner constituting member.

According to this method, the mutually screwed end portions of the liner constituting members are irradiated with the laser. Therefore, the end portions can satisfactorily be bonded to each other by laser welding without using any pressurizing jig or the like while preferably suppressing the positional deviation between the end portions. Even after the laser welding, the end portions are screwed. Therefore, the strength of the bonded portion can be improved.

Moreover, one preferable aspect of the manufacturing method of the gas container of the present invention described above may be as follows in the same manner as in the above-mentioned bonding method of two members.

Preferably, the engagement step is performed by screwing the external thread into the internal thread until a bonding surface of the end portion provided with the external thread comes into contact with the bonding surface of the end portion provided with the internal thread, and the irradiation step is performed by bonding the bonding surfaces brought into contact with each other by the laser welding. Preferably, this irradiation step is performed by bonding the bonding surfaces to each other in a circumferential direction by the laser welding. Preferably, the irradiation step is performed by bonding the mutually screwed external and internal threads at the bonding surfaces by the laser welding.

Moreover, preferably, the method further comprises, prior to the engagement step, a step of forming the substantially cylindrical end portion of one of the liner constituting members to be bonded to each other by a laser transmitting resin, and forming the substantially cylindrical end portion of the other liner constituting member by a laser absorbing resin, and the irradiation step is performed by irradiating the laser absorbing end portion with the laser from the side of the laser transmitting end portion to bond the bonding surfaces to each other by the laser welding. Further preferably, the external thread is a tapered external thread, and the internal thread is a tapered internal thread.

Furthermore, preferably, the method for manufacturing the gas container of the present invention further comprises, prior to the engagement step, a step of providing the external thread of a metal material at one of the liner constituting members to be bonded to each other by insertion molding, and providing the internal thread of the metal material at the other liner constituting member by the insertion molding.

In consequence, since the external thread and the internal thread are made of the metal material in the same manner as described above, a strong tightening force can be obtained. The external thread or the internal thread can easily be provided at the end portion of each resin member by the insertion molding.

To achieve the above-mentioned object, another gas container of the present invention has a resin liner constituted by bonding a plurality of liner constituting members having tubular end portions. A bonded portion between the liner constituting members has an engagement structure which engages the tubular end portions with each other, and a laser welded portion constituted by bonding the tubular end portions to each other by laser welding.

To achieve the above-mentioned object, another method for manufacturing a gas container of the present invention is a manufacturing method of a gas container having a resin liner constituted by bonding a plurality of liner constituting members having tubular end portions. The method comprises: an engagement step of engaging a tubular end portion of one of the liner constituting members to be bonded to each other with the tubular end portion of the other liner constituting member; and an irradiation step of irradiating the end portions subjected to the engagement step with laser to bond the end portions to each other by laser welding.

According to these constitutions, in a manufacturing process of the resin liner constituted by bonding the liner constituting members to each other, the end portions of the liner constituting members are engaged with each other by the engagement structure, and the end portions can be irradiated with the laser in this engaged state. In consequence, the positional deviation between the end portions can preferably be suppressed, and the end portions can satisfactorily be bonded to each other by laser welding without using any pressurizing jig or the like. Even after the laser welding, the bonded portion is engaged by the engagement structure in addition to the laser welded portion. Therefore, the strength of the bonded portion can be improved.

Here, the “resin member having the tubular end portion” includes that the resin member as a whole has a cylindrical shape, a square tubular shape such as a triangular shape or a quadrangular shape, an annular shape, a bowl-like shape or a domed shape. Examples of the engagement structure include click engagement in addition to snap fit and press-in.

According to the structure and the bonding method for two members of the present invention described above, in a state in which the positional deviation between the end portion of one resin member and the end portion of the other resin member is simply suppressed, the end portions can appropriately be bonded to each other by the laser welding.

According to the gas container of the present invention described above and the manufacturing method of the gas container, when one liner constituting member of the resin liner is similarly bonded to the other liner constituting member by the laser welding, the positional deviation between the end portions of the members can be suppressed. Therefore, the end portions can appropriately be bonded to each other.

### BRIEF DESCRIPTION OF THE DRAWINGS

FIG. 1 is a sectional view of a bonded structure of two members according to a first embodiment showing a state before bonding;

FIG. 2 is a sectional view of the bonded structure of two members according to the first embodiment showing a state after temporary bonding;

FIG. 3 is a sectional view of the bonded structure of two members according to the first embodiment showing a state after laser welding;

FIG. 4 is a sectional view of a bonded structure of two members according to a second embodiment showing a state before bonding;

FIG. 5 is a sectional view showing a constitution of a gas container according to a third embodiment;

FIG. 6 is an enlarged sectional view showing a bonded portion of the gas container according to the third embodiment;

FIG. 7 is a sectional view showing a constitution of the gas container according to a fourth embodiment;

FIG. 8 is an enlarged sectional view of the bonded portion according to a modification of the gas container of the third embodiment; and

FIG. 9 is an enlarged sectional view of a bonded portion of a gas container according to a fifth embodiment.

### BEST MODE FOR CARRYING OUT THE INVENTION

Preferable embodiments of the present invention will hereinafter be described with reference to the accompanying drawings. A characteristic part of the present embodiment lies in that, when two resin members having substantially cylindrical end portions are bonded, the end portions are engaged with each other and subjected to laser welding. A bonded structure of a pipe material made of a resin and a bonding method of the material will hereinafter be described according to first and second embodiments. A gas container in which this bonded structure is applied to a resin liner will be described together with a manufacturing method of the container according to third and fourth embodiments.

### First Embodiment

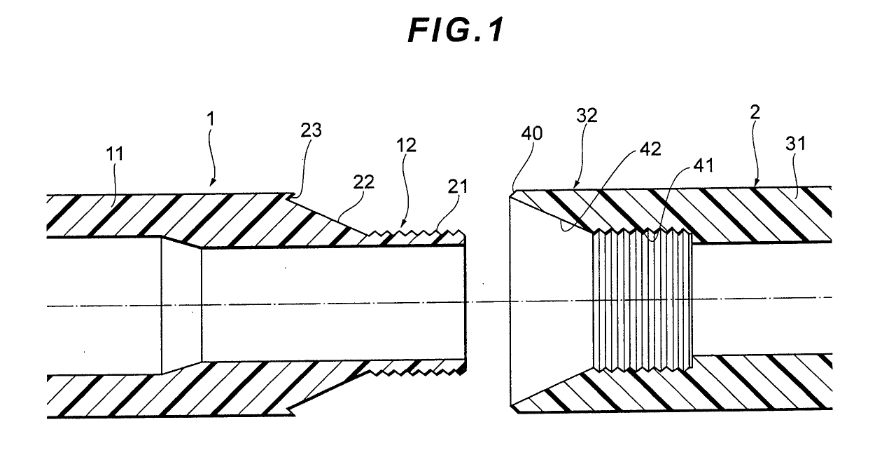

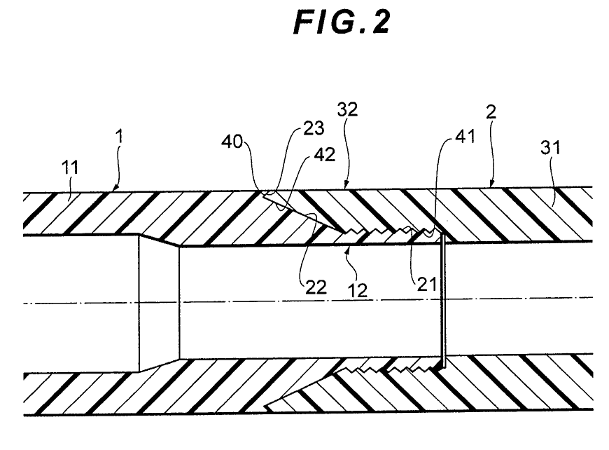

As shown in FIGS. 1 and 2, a pipe material 1 (a first resin member) made of a laser absorbing resin is bonded to a pipe material 2 (a second resin member) made of a laser transmitting resin to form one pipe-like molded resin material. Both of the pipe materials 1, 2 have a cylindrical shape as a whole, have an equal outer diameter, and are bonded to each other while the materials are aligned with each other in an axial direction.

The laser absorbing pipe material 1 has a trunk portion 11 which extends along a predetermined length in an axial direction of the material, and a substantially cylindrical bonding end portion 12 (a first end portion) formed on the side of one opened end of the trunk portion 11. An outer peripheral surface of the bonding end portion 12 has an external thread 21 formed on a tip-end side and having a diameter smaller than an outer diameter of the trunk portion 11, a bonding surface 22 sloped at a predetermined angle from a base end side of the external thread 21 to the trunk portion 11, and a stepped surface 23 formed between the bonding surface 22 and the outer peripheral surface of the trunk portion 11.

The external thread 21, the bonding surface 22 and the stepped surface 23 are formed in a circumferential direction of the bonding end portion 12. The external thread 21 is formed together with the whole shape of the pipe material 1, when the pipe material 1 is molded by use of various molding processes such as injection molding. The external thread 21 includes a parallel external thread which extends along a predetermined length in the axial direction. In addition, since the external thread 21 is formed of a tapered external thread, it is possible to improve tightness of a thread portion during bonding of the pipe materials 1, 2 to each other.

The bonding surface 22 is arranged integrally with a base end of the external thread 21, and formed in a tapered shape. The stepped surface 23 comprises a sloped surface slightly tilted toward the trunk portion 11 in a direction crossing the axial direction at right angles. In addition, the stepped surface 23 may be a surface having a direction crossing the axial direction at right angles or a sloped surface slightly tilted toward the bonding surface 22 with respect to the direction crossing the axial direction at right angles.

The laser transmitting pipe material 2 has a trunk portion 31 which extends along a predetermined length in the axial direction of the material, and a substantially cylindrical bonding end portion 32 (a second end portion) which is formed on the side of one opened end of the trunk portion 31 and which is to be bonded to the laser absorbing bonding end portion 12. An outer peripheral surface of the bonding end portion 32 is arranged on the same plane as that of an outer peripheral surface of the trunk portion 31, and has a chamfered tip end surface 40. The tip end surface 40 is constituted so as to abut on the stepped surface 23 in the circumferential direction so that the tip end surface is matched with and accepted by the stepped surface 23 described above.

An inner peripheral surface of the bonding end portion 32 has an internal thread 41 formed on the side of the trunk portion 31 and having a diameter larger than an inner diameter of the trunk portion 31, and a bonding surface 42 sloped at a predetermined angle from a tip-end side of the internal thread 41 to the tip end surface 40.

The internal thread 41 is formed together with the whole shape of the pipe material 2, when the pipe material 2 is molded by use of various molding processes such as the injection molding. The internal thread 41 includes a parallel internal thread which extends along a predetermined length in the axial direction in association with the external thread 21 including the parallel external thread. The bonding end portions 12, 32 engage with each other owing to a screwed structure (an engagement structure) between this external thread 21 and the internal thread 41. It is to be noted that, in a case where the external thread 21 is formed of a tapered external thread, the internal thread 41 is also formed of a tapered internal thread.

The bonding surface 42 is arranged integrally with a tip end of the internal thread 41, and formed into an inverted tapered shape. The bonding surface 42 is constituted so that the surface can be matched with the bonding surface 22 to abut on this bonding surface externally from a diametric direction in the circumferential direction. It is to be noted that it is preferable to smoothen the surfaces of the bonding surfaces 22, 42 so that the bonding surfaces 22, 42 come into contact with each other without any gap. The bonding surfaces 22, 42 have such an arbitrary angle that laser from a laser torch 50 as a laser irradiation device described later can be transmitted or received.

Here, the laser transmitting resin and the laser absorbing resin will be described. The laser transmitting resin constituting the pipe material 2 has thermoplasticity. This laser transmitting thermoplastic resin may have a transmitting property with respect to the laser to such an extent that energy required for laser welding is allowed to reach the bonding surface 22 on a laser absorbing side. Therefore, even the laser transmitting thermoplastic resin may slightly have a laser absorbing property. Examples of the laser transmitting thermoplastic resin include polyethylene, polypropylene and nylon 66, but a reinforcing fiber such as a glass fiber and a coloring agent may be added to these resins. For example, the laser transmitting pipe material 2 is made to be white, translucent or transparent.

The laser absorbing resin constituting the pipe material 1 has thermoplasticity. The laser absorbing thermoplastic resin may have an absorbing property with respect to the laser, and may generate heat to be melted by the absorbed laser. Examples of the laser absorbing thermoplastic resin include polyethylene, polypropylene and nylon 66, but a reinforcing fiber such as a glass fiber and a coloring agent may be added to these resins. For example, in a case where the laser absorbing thermoplastic resin is made of the same resin as the laser transmitting thermoplastic resin, more carbons may be added as compared with the laser transmitting thermoplastic resin. Therefore, the laser absorbing pipe material 1 is made to be, for example, black.

It is to be noted that instead of forming the whole pipe material 2 of the laser transmitting resin and forming the whole pipe material 1 of the laser absorbing resin, this type of laser transmitting or absorbing property may be imparted to a portion as a target of the laser welding. For example, both of a pair of pipe materials 1, 2 may be made of the laser transmitting resin beforehand, and the bonding end portion (or the bonding surface) of one of the pipe materials may be coated with an absorbent having the laser absorbing property, or a sheet in which this type of absorbent is kneaded may be attached.

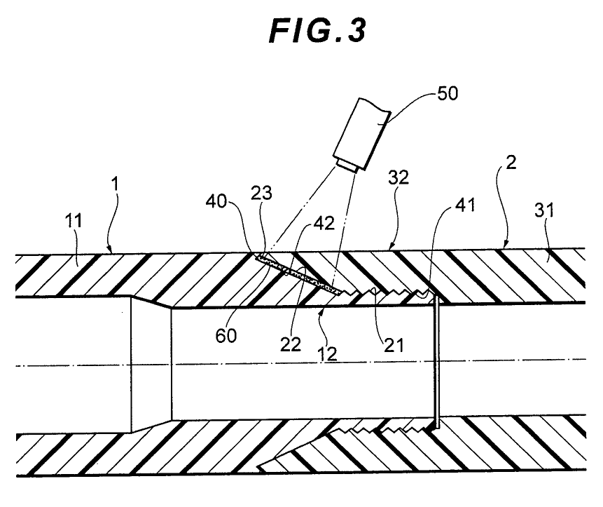

Here, a bonding method of two pipe materials 1, 2 will be described also with reference to FIG. 3. First, the bonding end portion 12 of the pipe material 1 is inserted into the bonding end portion 32 of the pipe material 2 to screw a part of the external thread 21 into a part of the internal thread 41. Furthermore, to insert the pipe material deeper, at least one of two pipe materials 1, 2 is rotated, and the external thread 21 is screwed into the internal thread 41 until the bonding surface 22 comes into contact with the bonding surface 42 while screwing the bonding end portion 12 into the bonding end portion 32.

In a case where a state is obtained in which the bonding surfaces 22, 42 abut on each other in the circumferential direction, the external thread 21 is screwed into the internal thread 41 along a predetermined length in the axial direction. Moreover, the stepped surface 23 abuts on the tip end surface 40 in the circumferential direction. In consequence, a pair of pipe materials 1, 2 are temporarily bonded (tentatively bonded) to each other. It is to be noted that in this state, a boundary between the outer peripheral surface of the bonding end portion 12 and the outer peripheral surface of the bonding end portion 32 is substantially the same plane without any gap. It can be confirmed that the bonding surface 22 comes into contact with the bonding surface 42 during the screwing by adjusting lengths of the external thread 21 and the internal thread 41 beforehand, or by confirming that the stepped surface 23 comes into contact with the tip end surface 40.

Subsequently, a pair of pipe materials 1, 2 in this tentatively bonded state are bonded to each other by the laser welding. The laser welding is performed by driving the laser torch 50 arranged outside the pair of pipe materials 1, 2, and irradiating the laser absorbing bonding end portion 12 with the laser emitted from the laser torch 50 from the side of the laser transmitting bonding end portion 32. The emitted laser transmits through the bonding end portion 32 on a tip-end side thereof to reach the laser absorbing bonding surface 22, and heats and melts the resin of this bonding surface 22. Moreover, the resin of the laser transmitting bonding surface 42 is heated and melted by heat conducted from the bonding surface 22. These melted resins are cooled to solidify. In consequence, a laser welded portion 60 is formed by integrally bonding the bonding surfaces 22, 42 to each other.

While the laser torch 50 is driven, the pair of temporarily bonded pipe materials 1, 2 are rotated around an axis thereof by a rotation device (not shown). In consequence, the bonding surface 22 is successively heated and melted in the circumferential direction, and the bonding surface 42 is successively heated and melted in the circumferential direction owing to this conducted heat. Therefore, when the pair of temporarily bonded pipe materials 1, 2 are rotated at least once, the laser welded portion 60 is formed by integrally bonding the bonding surfaces 22, 42 to each other in the circumferential direction thereof. When the laser welding is completed, the pair of temporarily bonded pipe materials 1, 2 are brought into a finally bonded state (i.e., a completely bonded state).

It is to be noted that in a case where the rotation device rotates the pair of pipe materials 1, 2, for example, so as to tighten the threads, a close contact property between the bonding surfaces 22 and 42 can further be improved. The pair of pipe materials 1, 2 may relatively rotate with respect to the laser torch 50. Therefore, instead of directly rotating the pair of pipe materials 1, 2, the laser torch 50 may directly be rotated around the pair of pipe materials 1, 2. Instead, both of the pair of pipe materials 1, 2 and the laser torch 50 may be rotated in the same direction or a reverse direction with respect to each other.

It is to be noted that semiconductor laser or the like may be used as the laser to be emitted by the laser torch 50, but the present invention is not limited to this laser, and a type of laser is appropriately selected in consideration of properties including a thickness of the resin of the laser transmitting bonding end portion 32. Moreover, various conditions such as an output (an irradiation amount) of the laser and rotation speeds of the pair of pipe materials 1, 2 may appropriately be set in accordance with properties of the pipe materials 1, 2.

As described above, according to the present embodiment, when the pair of pipe materials 1, 2 are bonded by the laser welding, the bonding surfaces 22, 42 can be held so as to come into close contact with each other owing to a screwed structure between the external thread 21 and the internal thread 41. In consequence, while preferably suppressing a positional deviation between the bonding surfaces 22 and 42, the surfaces can be irradiated with the laser.

Therefore, even if any pressurizing jig or the like is not used, the bonding surfaces 22, 42 can satisfactorily be bonded to each other by the laser welding. Moreover, a bonded portion between the pair of pipe materials 1 and 2 subjected to the laser welding is bonded by not only the laser welded portion 60 but also thread tightening due to the screwed structure. Therefore, bonding strength and tightness of this bonded portion can be improved.

It is to be noted that various modifications may be applied to the bonded structure of two members in the present embodiment. For example, even the mutually screwed external thread 21 and internal thread 41 may be irradiated with the laser to bond a screwed portion between the external thread 21 and the internal thread 41 by the laser welding. The bonding surface 22 is tapered, and the bonding surface 42 is inverted tapered. However, needless to say, these surfaces may be constituted of flat surfaces crossing the axial direction at right angles, or constituted of surfaces having stepped portions.

Furthermore, the pipe materials (1, 2) have been described as examples of the resin members, but the present invention may be applied to various molded resin materials such as a car component and a piping line component. For example, even in a case where an intake manifold is constituted of a plurality of resin members, the screwed structure is provided as described above, and the mutually screwed resin members may be irradiated with the laser and bonded to each other.

### Second Embodiment

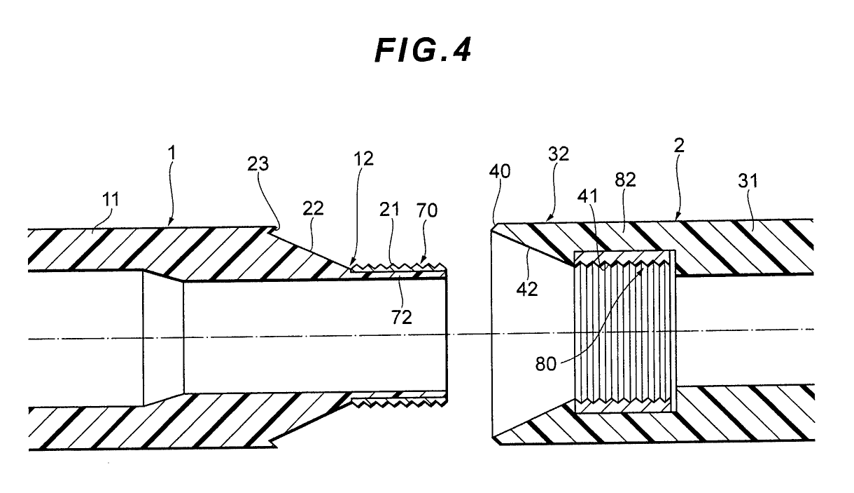

Next, mainly different respects of a bonded structure of two members and a bonding method of the members according to a second embodiment will be described with reference to FIG. 4. The embodiment is different from the first embodiment in that an external thread 21 and an internal thread 41 are made of a metal material. It is to be noted that a part common to the first embodiment is denoted with the same reference numerals as those of the first embodiment, and detailed description thereof is omitted.

A metal sleeve 70 having the external thread 21 on an outer peripheral surface thereof is provided on an outer periphery of a small-diameter cylindrical portion 72 formed on a tip end of a bonding end portion 12. The metal sleeve 70 is formed on a pipe material 1 by insertion molding. It is to be noted that the metal sleeve may be fitted into the outer periphery of the small-diameter cylindrical portion 72, or bonded with adhesive in this fitted state.

A metal sleeve 80 having the internal thread 41 on an inner peripheral surface thereof is provided on an inner periphery of a cylindrical portion 82 formed at an inner portion of a bonding end portion 32. The metal sleeve 80 is similarly formed on a pipe material 2 by insertion molding. However, needless to say, the metal sleeve may be fitted into the cylindrical portion 82, or bonded with adhesive in this state. Examples of a type of a metal of these metal sleeves 70, 80 include steel, but the present embodiment is not limited to this type. In the same manner as in the above embodiment, the external thread 21 may be formed of a tapered external thread, and the internal thread 41 may be formed of a tapered internal thread.

According to the present embodiment, the external thread 21 and the internal thread 41 are made of the metal. Therefore, as compared with a case where these threads are made of a resin, a strong tightening force can be obtained. In consequence, a positional deviation between the bonding surfaces 22 and 42 can more preferably be suppressed, and the bonding surfaces 22, 42 can satisfactorily be bonded to each other by laser welding. It is to be noted that even in the present embodiment, various modifications described in the first embodiment may be applied.

It is to be noted that instead of the metal sleeve 70, a resin sleeve having the external thread 21 on an outer peripheral surface thereof may be constituted of a resin which is harder than that of the pipe material 1. Similarly, instead of the metal sleeve 80, a resin sleeve having the internal thread 41 on an inner peripheral surface thereof may be constituted of a resin which is harder than that of the pipe material 2.

### Third Embodiment

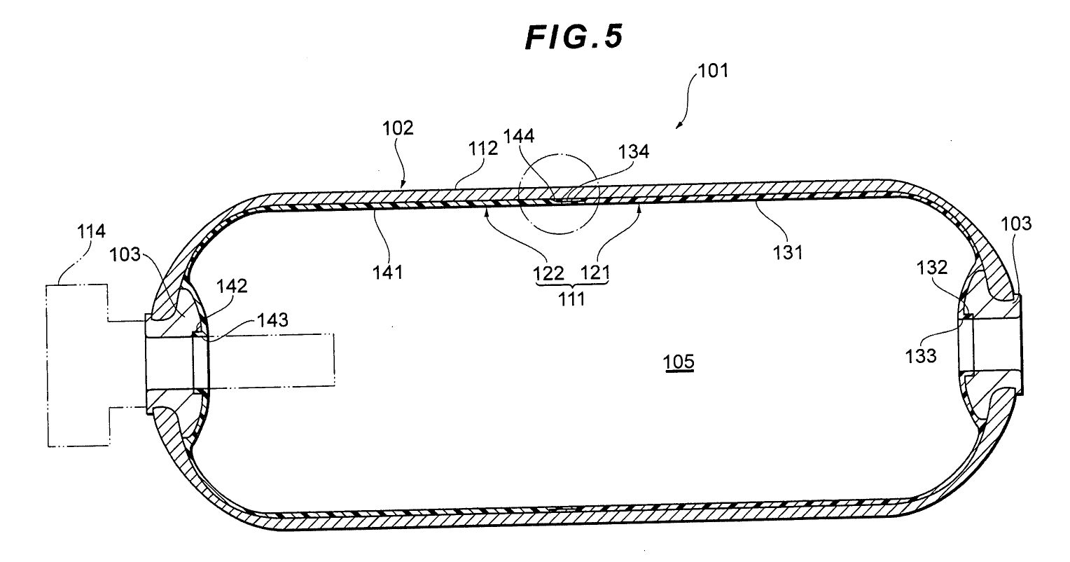

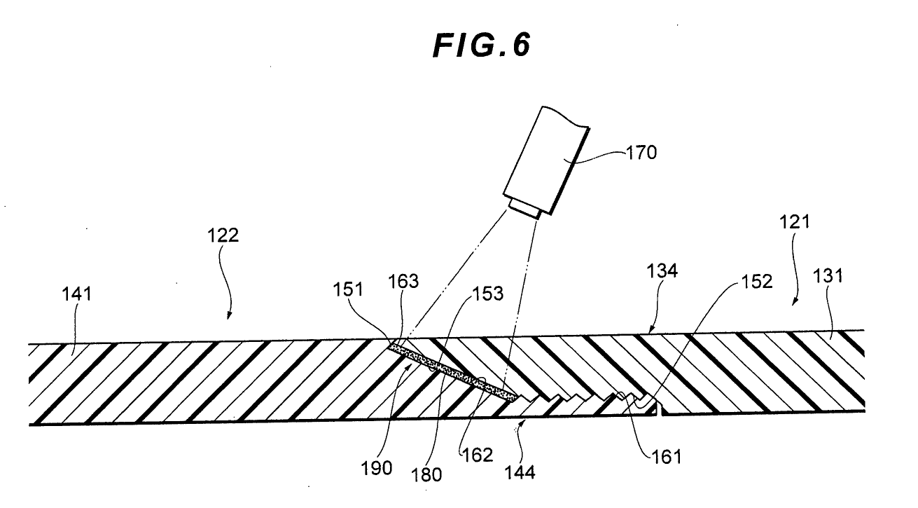

Next, a gas container and a bonding method of the container according to a third embodiment will be described with reference to FIGS. 5 and 6. In the present embodiment, a bonded structure of two members of the first embodiment is applied to a resin liner of the gas container, and end portions of a liner constituting member constituting the resin liner are bonded to each other. First, a structure of the gas container will hereinafter be described. Subsequently, a manufacturing method of the gas container will briefly be described.

As shown in FIG. 5, a gas container 101 includes a container main body 102 having a hermetically sealed cylindrical shape as a whole; and mouthpieces 103, 103 attached to opposite end portions of the container main body 102 in a longitudinal direction. An inner part of the container main body 102 is a storage space 105 to store various types of gases. The gas container 101 may be filled with gas having a normal pressure, or gas having a raised pressure as compared with the normal pressure. That is, the gas container 101 of the present invention can function as a high-pressure gas container.

For example, in a fuel cell system, a pressure of fuel gas prepared in a high-pressure state is reduced to use the gas in power generation of a fuel cell. The gas container 101 of the present invention may be applied to storage of high-pressure combustible fuel gas, and hydrogen gas, compressed natural gas (a CNG gas) or the like as the fuel gas may be stored. A pressure of the hydrogen gas stored in the gas container 101 is, for example, 35 MPa or 70 MPa, and a pressure of the CNG gas is, for example, 20 MPa. The high-pressure hydrogen gas container 101 will hereinafter be described as an example.

The container main body 102 has a two-layer structure including an inner resin liner 111 (an inner shell) having a gas barrier property and a reinforcing layer 112 (an outer shell) arranged on an outer periphery of the resin liner 111. The reinforcing layer 112 is made of, for example, FRP including a carbon fiber and an epoxy fiber, and this layer is wound so as to cover an outer surface of the resin liner 111.

The mouthpiece 103 is made of a metal such as stainless steel, and provided at the center of a semi-spherical end wall portion of the container main body 102. An inner peripheral surface of an opening of the mouthpiece 103 is provided with an internal thread, and functional components such as a piping line and a valve assembly 114 (a valve body) can be screwed into and connected to the mouthpiece 103 via this internal thread. It is to be noted that in FIG. 5, an example in which only one of the mouthpieces 103, 103 is provided with the valve assembly 114 is shown by a two-dot chain line.

For example, in the gas container 101 of the fuel cell system, the storage space 105 is connected to an outer gas channel (not shown) via the valve assembly 114 in which piping line elements such as a valve and a joint are integrally incorporated, and the storage space 105 is filled with hydrogen.

Moreover, hydrogen is discharged from the storage space 105. It is to be noted that the mouthpieces 103, 103 are provided at the opposite end portions of the gas container 101. However, only one end portion may be provided with the mouthpiece 103.

The resin liner 111 is constituted by bonding a pair of liner constituting members 121, 122 (divided materials) divided into two members at the center in the longitudinal direction and substantially having the same shape by laser welding. That is, the liner constituting members 121, 122 as divided hollow halves are bonded to each other by the laser welding to constitute the resin liner 111 having an inner hollow part.

In a pair of liner constituting members 121, 122, the liner constituting member 121 (a second liner constituting member) is made of, for example, a laser transmitting thermoplastic resin in the same manner as in the pipe material 2 of the first embodiment. The liner constituting member 122 (a first liner constituting member) is made of a laser absorbing thermoplastic resin in the same manner as in the pipe material 1 of the first embodiment. The pair of liner constituting members 121, 122 each has trunk portions 131, 141 which extend along a predetermined length of the resin liner 111 in an axial direction, respectively. Opposite end sides of the trunk portions 131, 141 in the axial direction are opened.

One liner constituting member 121 has a return portion 132 formed at an end portion having a reduced diameter on one end side of the trunk portion 131, a communicating portion 133 opened at the center of the return portion 132, and a substantially cylindrical bonding end portion 134 (a second end portion) on the other end side of the trunk portion 131. The return portion 132 functions so as to secure strength of the liner constituting member 121. The mouthpiece 103 is positioned between an outer peripheral surface of the return portion 132 and an end portion of the reinforcing layer 112, and the mouthpiece 103 is fitted into the communicating portion 133.

The bonding end portion 134 is formed in the same manner as in the bonding end portion 32 of the pipe material 2 of the first embodiment. That is, as shown in FIG. 6, the bonding end portion 134 has a chamfered tip end surface 151 on an outer peripheral surface thereof, and has an internal thread 152 and a bonding surface 153 on an inner peripheral surface thereof.

These tip end surface 151, internal thread 152 and bonding surface 153 are constituted in the same manner as in the tip end surface 40, internal thread 41 and bonding surface 42 of the first embodiment. Moreover, a modification (e.g., a tapered internal thread or the like) may be applied to these tip end surface 151, internal thread 152 and bonding surface 153 in the same manner as in the first embodiment. Here, a detailed description thereof is omitted.

The other liner constituting member 122 has a return portion 142 formed at an end portion having a reduced diameter on one end side of the trunk portion 141, a communicating portion 143 opened at the center of the return portion 142, and a substantially cylindrical bonding end portion 144 (a first end portion) on the other end side of the trunk portion 141.

The return portion 142 functions so as to secure strength of the liner constituting member 122, and the mouthpiece 103 is fitted into the communicating portion 143. It is to be noted that in a case where the mouthpiece 103 is provided at only one end portion of the resin liner 111, in one of the pair of liner constituting members 121, 122, one of the trunk portions 131, 141 on one end side is formed of a closed end.

The bonding end portion 144 is formed in the same manner as in the bonding end portion 12 of the pipe material 1 of the first embodiment. That is, as shown in FIG. 6, an outer peripheral surface of the bonding end portion 144 has an external thread 161 to be screwed into the internal thread 152, a bonding surface 162 which is matched with the bonding surface 153 to abut on this bonding surface in a circumferential direction, and a stepped surface 163 capable of accepting the tip end surface 151.

These external thread 161, bonding surface 162 and stepped surface 163 are constituted in the same manner as in the external thread 21, bonding surface 22 and stepped surface 23 of the first embodiment. Moreover, a similar modification (e.g., a tapered external thread or the like) may be applied.

Therefore, in a state in which the liner constituting members 121, 122 of the gas container 101 are bonded to each other, the bonding end portions 134, 144 are engaged with each other by a screwed structure including the external thread 161 and the internal thread 152. In this state, a laser welded portion 180 which integrally bonds the bonding surfaces 153,162 to each other is formed in an interface between the bonding surfaces 153 and 162. In consequence, a bonded portion 190 between the liner constituting members 121 and 122 is provided with the laser welded portion 180 in the vicinity of the screwed structure including the external thread 161 and the internal thread 152. The bonding end portions 134,144 are bonded to each other so that the outer peripheral surfaces of the portions are the same plane.

It is to be noted that instead of making the whole liner constituting member 121 of a laser transmitting resin and making the whole liner constituting member 122 of a laser absorbing resin, this type of laser transmitting or absorbing property may be imparted to a portion as a target of the laser welding.

Here, the liner constituting members 121, 122 mentioned in the present description are members constituting the resin liner 111 having a divided structure, and are members having substantially cylindrical end portions as described above. Therefore, the liner constituting members 121, 122 may have a substantially cylindrical shape on at least one end side, and the shape of the member as a whole has a shape such as a cylindrical shape, an annular shape, a bowl-like shape or a domed shape.

A manufacturing method of the gas container 1 will briefly be described with reference to FIGS. 3 and 4.

First, a pair of liner constituting members 121, 122 and two mouthpieces 103, 103 are molded. At this time, for example, one mouthpiece 103 molded beforehand is arranged in a mold, and a laser transmitting thermoplastic resin is injected into this mold to integrally mold the liner constituting member 121 and the mouthpiece 103 (insertion molding is performed).

Moreover, by a similar procedure, the laser absorbing thermoplastic resin is injected to integrally mold the liner constituting member 122 and the mouthpiece 103. Since injection molding is used in this manner, the liner constituting members 121, 122 can be molded with a good molding precision. It is to be noted that instead of the injection molding, rotation molding and blow molding may be used.

Subsequently, the liner constituting members 121, 122 provided with the mouthpieces 103 are arranged in, for example, a laterally directed posture in a manufacturing equipment, the liner constituting members 121, 122 are allowed to face each other, and a part of the external thread 161 is screwed into a part of the internal thread 152.

Furthermore, at least one of two liner constituting members 121, 122 is rotated. In addition, while the external thread 161 is screwed into the internal thread 152 until the bonding surface 153 comes into contact with the bonding surface 162, the bonding end portion 144 is screwed into the bonding end portion 134. When the screwing is completed, the bonding surfaces 153, 162 are allowed to abut on each other in the circumferential direction. Moreover, the stepped surface 163 is allowed to abut on the tip end surface 151 in the circumferential direction to obtain the resin liner 111 in a state in which the liner constituting members 121, 122 are temporarily bonded (tentatively bonded) to each other.

It is to be noted that subsequently, plugs (not shown) are screwed into and connected to the mouthpieces 103, 103 of the liner constituting members 121, 122 to substantially hermetically seal the temporarily bonded resin liner 111 so that impurities are prevented from entering this hermetically sealed space.

Subsequently, a laser welding step is executed in the same manner as in the first embodiment. That is, while driving a laser torch 170 arranged outside the temporarily bonded resin liner 111, the resin liner 111 is rotated around the axis by the rotation device (not shown) in synchronization with the driving of the laser torch. The laser absorbing bonding end portion 144 is irradiated with the laser from the side of the laser transmitting bonding end portion 134, and the resins of the bonding surfaces 162 and 153 are successively heated and melted in the circumferential direction.

It is to be noted that, for example, when the rotation device rotates the resin liner 111 so as to tighten the threads, a close contact property between the bonding surfaces 153 and 162 can further be improved. The resin liner 111 may be configured to rotate relatively with respect to the laser torch 170 during the irradiation with the laser. Furthermore, semiconductor laser or the like may be used as the laser to be emitted by the laser torch 170, but the present embodiment is not limited to this laser.

When the resin liner 111 is rotated at least once, the laser welded portion 180 is formed in the circumferential direction by integrally bonding the bonding surfaces 153, 162 to each other. In consequence, the temporarily bonded resin liner 111 is brought into a finally bonded state (i.e., a completely bonded state). After the laser welding is completed, the reinforcing layer 112 is formed on an outer surface of the resin liner 111 by a filament winding process or the like to manufacture the gas container 101.

As described above, according to the present embodiment, when the liner constituting members 121, 122 of the resin liner 111 are bonded to each other by the laser welding in a manufacturing process of the gas container 101, the bonding surfaces 153, 162 can be held so as to come into close contact with each other by the screwed structure of the external thread 161 and the internal thread 152.

Therefore, a positional deviation between the bonding surfaces 153 and 162 can preferably be suppressed. Even if any pressurizing jig or the like is not used, the bonding surfaces 153, 162 can satisfactorily be bonded to each other by the laser welding. Since the resin liner 111 subjected to the laser welding is bonded by not only the laser welded portion 180 but also thread tightening due to the screwed structure, bonding strength and tightness of this bonded portion 190 can be improved.

It is to be noted that even in the present embodiment, various modifications may be applied as described in the first embodiment. For example, even the mutually screwed external thread 161 and internal thread 152 may be irradiated with the laser to bond a screwed portion between the external thread 161 and the internal thread 152 by the laser welding.

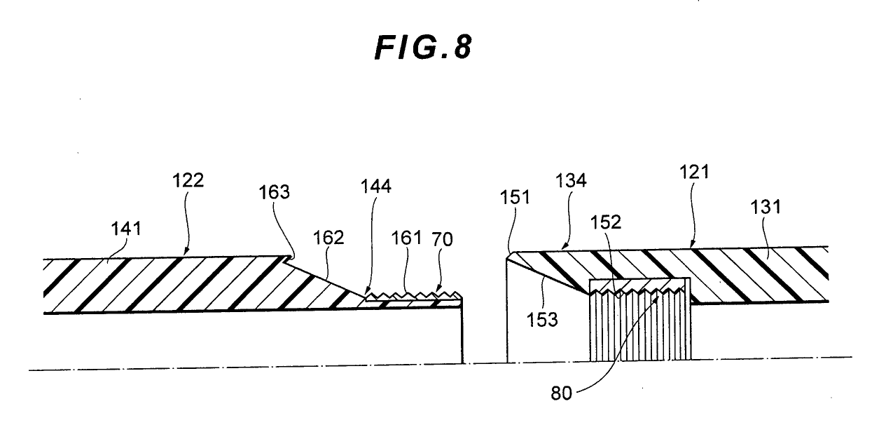

Moreover, even in the present embodiment, a constitution of the second embodiment may be applied in which the external thread 161 and the internal thread 152 are made of a metal material. In this case, for example, as shown in FIG. 8, when the liner constituting member 121 (and the mouthpiece 103) is molded, the metal sleeve 80 having the internal thread 152 may be provided at the liner constituting member 121 for insertion molding. Similarly, when the liner constituting member 122 (and the mouthpiece 103) is molded, the metal sleeve 70 having the external thread 161 may be provided at the liner constituting member 122 by the insertion molding.

### Fourth Embodiment

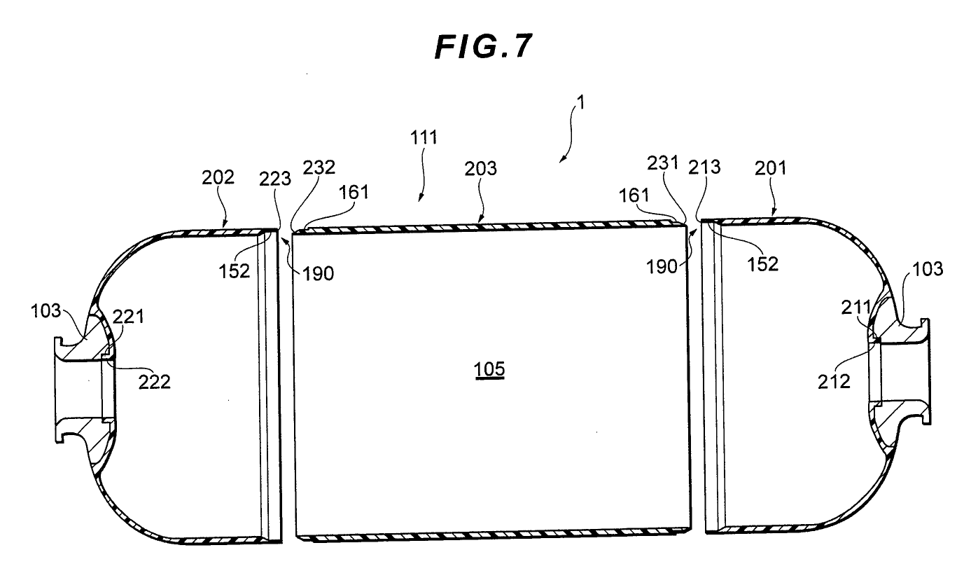

Next, different respects of a gas container and a bonding method of the container according to a fourth embodiment will mainly be described with reference to FIG. 7. The present embodiment is different from the third embodiment in that a resin liner 111 of a gas container 101 includes three liner constituting members 201, 202 and 203. It is to be noted that in FIG. 7, a reinforcing layer 112 is omitted.

The resin liner 111 is constituted by bonding three liner constituting members 201, 202 and 203 divided into three members in a longitudinal direction by laser welding. Two liner constituting members 201, 202 positioned at opposite ends are formed into a bowl-like shape as a whole. The liner constituting member 203 positioned at the center is formed into a cylindrical or annular shape as a whole. Two liner constituting members 201, 202 at the opposite ends are molded integrally with mouthpieces 3 by, for example, injection molding, respectively. The central liner constituting member 203 is formed by, for example, injection molding.

The two liner constituting members 201, 202 at the opposite ends have bonding end portions 213, 223 on sides opposite to mouthpieces 103, 103 in addition to return portions 211, 221 and communicating portions 212, 222, respectively. The bonding end portions 213, 223 are constituted of bonding end portions (134) having internal threads 152 in the same manner as described above, and have a laser transmitting property.

The central liner constituting member 203 has bonding end portions 231, 232 on opposite opened end sides in an axial direction. The bonding end portions 231 and 232 are constituted of bonding end portions (144) having external threads 161 in the same manner as described above, and have a laser absorbing property. It is to be noted that, needless to say, the bonding end portions 213, 223 may have a laser absorbing property on an external side of the screwed structure, and the bonding end portions 231, 232 may have a laser transmitting property on an internal side of the screwed structure. In the resin liner 111, the screwed bonding end portions 213, 231 are bonded to each other by the laser welding, and the screwed bonding end portions 223, 232 are bonded to each other by the laser welding.

The manufacturing method of each embodiment described above may be applied to the manufacturing method of the gas container 101 of the present embodiment. Here, a case where three liner constituting members 201, 202 and 203 are simultaneously bonded by the laser welding will briefly be described.

First, three liner constituting members 201, 202 and 203 including the liner constituting members (201, 202) provided with the mouthpieces 103 are molded. Subsequently, the bonding end portion 213 is screwed into the bonding end portion 231, and bonding surfaces of the end portions are brought into contact with each other. Moreover, the bonding end portion 223 is screwed into the bonding end portion 232, and bonding surfaces of these portions are brought into contact with each other. In consequence, the resin liner 111 is obtained in a state in which all of the liner constituting members 201, 202 and 203 are temporarily bonded (tentatively bonded).

Moreover, while the temporarily bonded resin liner 111 is relatively rotated around an axis thereof in synchronization with driving of two laser torches 170, the bonding end portions 213, 231 are bonded to each other, and the bonding end portions 223, 232 are bonded to each other by the laser welding in the circumferential direction. In consequence, a bonded portion 190 is provided with a laser welded portion (180), the resin liner 111 is finally bonded, and a reinforcing layer 112 is finally provided to thereby manufacture the gas container 101. Therefore, even when the three liner constituting members 201, 202 and 203 constitute the resin liner 111 as in the present embodiment, the gas container 101 can be manufactured in the same manner as in the above embodiments.

It is to be noted that an example has been described in which the three liner constituting members 201, 202 and 203 are simultaneously subjected to treatments such as the temporary bonding and the laser welding. However, needless to say, these treatments may separately be performed. A case where three liner constituting members are arranged has been described, but this also applies to four or more liner constituting members. That is, the present invention can be applied to the resin liner 111 constituted by bonding a plurality of liner constituting members arranged in the axial direction.

It is to be noted that the gas container 101 according to the third and fourth embodiments has the screwed structure including the external thread 161 and the internal thread 152 at the laser welded portion 180 itself and in the vicinity of the laser welded portion, but an engagement structure other than this screwed structure may be used. For example, the bonding end portions 134, 144 of the third embodiment may be engaged so as to come into contact with each other by the engagement structure. This type of engagement structure may include, for example, snap-fitting, press-in or the like.

### Fifth Embodiment

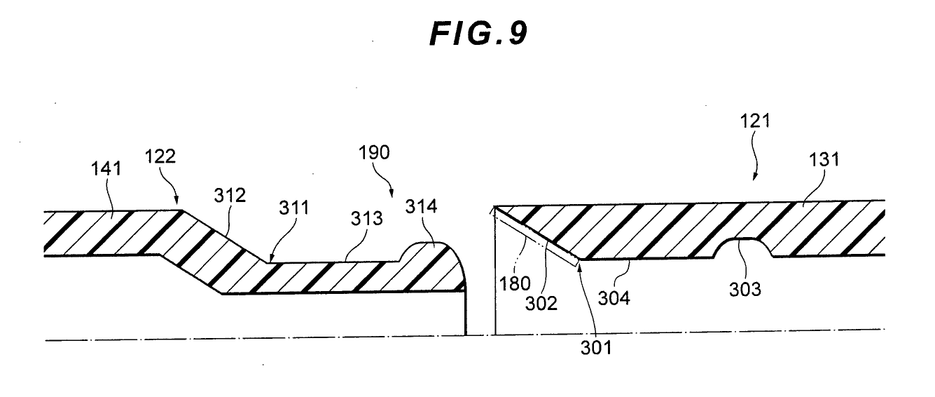

Next, different respects of a gas container and a bonding method of the container according to a fifth embodiment will mainly be described with reference to FIG. 9. The present embodiment is mainly different from the third embodiment in that bonding end portions 301, 311 are engaged with each other by use of an engagement structure other than a screwed structure.

A liner constituting member 121 has a tubular bonding end portion 301 on the other end side of a trunk portion 131. The bonding end portion 301 has a bonding surface 302 formed at the other end of the trunk portion 131, and an engagement concave portion 303 formed in the vicinity of the bonding surface 302. The bonding surface 302 is sloped at a predetermined angle with respect to an axial direction of a resin liner 11, and formed into an inverted tapered shape. The engagement concave portion 303 is recessed at an inner peripheral surface of the liner constituting member 121. The engagement concave portion 303 has a semi-circular sectional shape, but may appropriately be designed into a trapezoidal shape or the like. The engagement concave portion 303 is arranged with the bonding surface 302 via a contact surface 304. The contact surface 304 is a part of an inner peripheral surface of the liner constituting member 121, and is formed to be tubular.

A liner constituting member 122 has a tubular bonding end portion 311 on the other end side of a trunk portion 141. The bonding end portion 311 has a bonding surface 312, a contact surface 313 and an engagement convex portion 314. The bonding surface 312 is a part of an outer peripheral surface of the liner constituting member 122, and formed into a tapered shape in association with the bonding surface 302. The bonding surface 312 is configured so that the surface can be matched with the bonding surface 302 to abut on this bonding surface externally from a diametric direction in a circumferential direction. It is to be noted that it is preferable to smoothen the bonding surfaces 302, 312 so that these surfaces come into contact with each other without any gap. The bonding surfaces 302, 312 may have such an arbitrary angle that laser from a laser torch 50 as a laser irradiation device can be transmitted or received.

The contact surface 313 is a part of an outer peripheral surface of the liner constituting member 122, and is formed to be tubular. The contact surface 313 extends in the axial direction of the resin liner 11 to an extent equal to that of the contact surface 304. The contact surface 313 is configured so that the surface can be matched with the contact surface 304 to abut on this contact surface externally from the diametric direction in the circumferential direction.

The engagement convex portion 314 is arranged with the bonding surface 312 via the contact surface 313. However, in another embodiment, the engagement convex portion 314 does not have to be formed at a tip end of the liner constituting member 122, and may be formed so as to be directly arranged with the bonding surface 312. The engagement convex portion 314 is formed so as to protrude from an outer peripheral surface of a tip end of the liner constituting member 122. However, the surface of the engagement convex portion 314 is positioned internally from an outer peripheral surface of the trunk portion 141 in the diametric direction. The engagement convex portion 314 engages with the engagement concave portion 303 in a clicked manner. That is, the engagement convex portion 314 and the engagement concave portion 303 constitute an engagement structure which engages the bonding end portions 301, 311 with each other.

Therefore, in a state in which the liner constituting members 121,122 of the gas container 101 are bonded to each other, the bonding end portions 301, 311 are engaged with each other by the engagement structure including the engagement convex portion 314 and the engagement concave portion 303. In this state, a laser welded portion 180 which integrally bonds the bonding surfaces 302, 312 to each other is formed at an interface between the bonding surfaces 302 and 312. It is to be noted that in FIG. 9, the laser welded portion 180 is virtually shown in a two-dot chain line. In the bonded state, the outer peripheral surfaces of the bonding end portions 301, 311 are the same plane. The contact surfaces 304, 313 come into close contact with each other.

According to the manufacturing method of a gas container 1 of the present embodiment, after molding the liner constituting members 121, 122 in the same manner as in the third embodiment, the engagement convex portion 314 is engaged with the engagement concave portion 303. In consequence, the bonding surfaces 302, 312 abut on each other, and the contact surfaces 304, 313 abut on each other in the circumferential direction, and the resin liner 111 is obtained in a state in which the liner constituting members 121, 122 are temporarily bonded (tentatively bonded) to each other. Subsequently, when a laser welding step is executed to bond the bonding surfaces 302, 312 to each other by the laser welding in the circumferential direction, the laser welded portion 180 is formed between these bonding surfaces. At this time, a region to be subjected to the laser welding may include a region between the contact surfaces 304 and 313 and/or a region between the engagement concave portion 303 and the engagement convex portion 314. Since the laser welded portion 180 is formed, the temporarily bonded resin liner 111 is brought into a finally bonded state. Moreover, through a subsequent step, a gas container 101 is manufactured in which an outer surface of the resin liner 111 is provided with a reinforcing layer 112.

As described above, according to the present embodiment, when the liner constituting members 121, 122 of the resin liner 111 are bonded to each other by the laser welding in a manufacturing process of the gas container 101, the engagement structure including the engagement concave portion 303 and the engagement convex portion 314 can hold the bonding surfaces 302, 312 so that the bonding surfaces come into close contact with each other.

Therefore, a positional deviation between the bonding surfaces 302 and 312 can be suppressed, and the bonding surfaces 302, 312 can satisfactorily be bonded to each other by the laser welding. The resin liner 111 subjected to the laser welding is temporarily bonded by not only the laser welded portion 180 but also the engagement structure. Therefore, bonding strength and tightness of this bonded portion 190 can be improved. In a case where a gas is stored in the gas container 1, the bonding surface 312, the contact surface 313 and the engagement convex portion 314 are pressed onto the bonding surface 302, the contact surface 304 and the engagement concave portion 303, respectively, owing to an inner pressure of the container. Since the contact surfaces 313, 304 are formed, the bonding end portions 301, 311 can be brought into contact with each other with a comparatively large pressure receiving area.

It is to be noted that a shape of the bonding end portions 301, 311 applicable to the fifth embodiment is not limited to a cylindrical shape, an annular shape, a bowl-like shape and a domed shape, and may be a square tubular shape such as a triangular or quadrangular shape.

### Modification

Moreover, in all of the above embodiments, when laser welding is executed, various manufacturing equipments may be used. An example applied to a gas container 101 will be described. For example, a temporarily bonded resin liner 111 may be arranged in a chamber, the inside of the chamber may be brought into an inactive gas atmosphere or a vacuum state, and screwed bonding portions 134, 144 may be laser-welded to each other. In consequence, a low oxygen atmosphere can be obtained as compared with outside air. The bonding end portions 134, 144 are prevented from being oxidized. Therefore, a bonding precision can further be improved.

Furthermore, a pressure difference is applied internally and externally to the resin liner 111 during the laser welding to improve a close contact property between the bonding surfaces (22 and 42 or 153 and 162). The pressure difference may be applied by reducing a pressure in the resin liner 111 or pressurizing the inside of the resin liner via a mouthpiece 103 of the resin liner 111 by use of, for example, a pump. In consequence, in a state in which a close contact force between the bonding surfaces 153 and 162 is increased, the bonding surfaces can be bonded to each other by the laser welding.

1. A bonded structure of two members comprising:
a first resin member having at least a substantially cylindrical first end portion, and
a second resin member having at least a substantially cylindrical second end portion,
wherein an outer peripheral surface of the first end portion has an external thread and a first bonding surface,
an inner peripheral surface of the second end portion has an internal thread into which the external thread is screwed and a second bonding surface which is matched with the first bonding surface to abut on the first bonding surface,
the first bonding surface is bonded to the second bonding surface by laser welding, and the screwed external and internal threads are bonded by the laser welding.

2. The bonded structure of two members according to claim 1,
wherein the first bonding surface is sloped, and the second bonding surface is sloped in association with the first bonding surface.

3. (canceled)

4. The bonded structure of two members according to claim 1, wherein the second end portion is made of a laser transmitting resin, and the first end portion is made of a laser absorbing resin.

5. (canceled)

6. The bonded structure of two members according to claim 1, wherein the external thread is a tapered external thread, and the internal thread is a tapered internal thread.

7. A bonding method of two members, the two members comprising a first resin member having at least a substantially cylindrical first end portion and a second resin member having at least a substantially cylindrical second end portion,
wherein an outer peripheral surface of the end portion of the first resin member has an external thread and a first bonding surface, an inner peripheral surface of the end portion of the second resin member has an internal thread into which the external thread is screwed and a second bonding surface which is matched with the first bonding surface to abut on the first bonding surface,
the method comprising:
irradiating, with laser, the first bonding surface and the second bonding surface in a state in which the external thread is screwed into the internal thread to bond the first bonding surface to the second bonding surface by laser welding, and,
irradiating the screwed external and internal threads with laser to bond the external thread to the internal thread by laser welding.

8. The bonding method of two members according to claim 7, wherein after screwing the external thread into the internal thread until the first bonding surface comes into contact with the second bonding surface, the irradiation of laser is performed.

9. The bonding method of two members according to claim 8, wherein the first bonding surface is bonded to the second bonding surface in a circumferential direction by the laser welding.

10. The bonding method of two members according to claim 8, wherein the end portion of one of the first and second resin members is made of a laser transmitting resin, the end portion of the other resin member of the first and second resin members is made of a laser absorbing resin beforehand, and the irradiation of laser is performed from the side of the laser transmitting end portion toward the laser absorbing end portion.

11. A gas container comprising:
a resin liner constituted by bonding a pair of liner constituting members as the first and second resin members to each other by use of the bonding method of two members according to claim 7; and
a reinforcing layer arranged on an outer periphery of the resin liner.

12. A gas container comprising a resin liner,
the resin liner including a first liner constituting member having at least a substantially cylindrical first end portion and a second liner constituting member having at least a substantially cylindrical second end portion,
wherein an outer Peripheral surface of the first end portion has an external thread and a first bonding surface,
an inner peripheral surface of the second end portion has an internal thread into which the external thread is screwed and a second bonding surface which is matched with the first bonding surface to abut on the first bonding surface,
the first bonding surface is bonded to the second bonding surface by laser welding, and the screwed external and internal threads are bonded by the laser welding.

13. The gas container according to claim 12, wherein the first bonding surface is sloped, and the second bonding surface is sloped in association with the first bonding surface.

14. The gas container according to claim 12, wherein the second end portion is made of a laser transmitting resin, and
the first end portion is made of a laser absorbing resin.

15. (canceled)

16. The gas container according to claim 12, wherein the external thread is formed integrally with the first end portion, and
the internal thread is formed integrally with the second end portion.

17. The gas container according to claim 12, wherein the outer peripheral surfaces of the first and second liner constituting members are bonded to have the same plane.

18. The gas container according to claim 12, wherein the external thread is a tapered external thread, and
the internal thread is a tapered internal thread.

19. The gas container according to claim 12, wherein the first and second end portions are provided at the resin liner in a circumferential direction.

20. The gas container according to claim 12, wherein at least one of the first and second liner constituting members has a communicating portion which is arranged on a side opposite to a bonded portion to be bonded to the other liner constituting member and which allows an inner hollow of the resin liner to communicate with the outside.

21. The gas container according to claim 12, wherein the gas container is configured to store combustible gas having a high pressure.

22. The gas container according to claim 12, further comprising:
a container main body having the resin liner and a reinforcing layer arranged on an outer periphery of the resin liner; and
a mouthpiece provided at one end portion of the container main body.

23. (canceled)

24. A manufacturing method of a gas container having a resin liner,
the resin liner including a first liner constituting member having at least a substantially cylindrical first end portion and a second liner constituting member having at least a substantially cylindrical second end portion,
wherein the first end portion has an external thread and a first bonding surface, and the second end portion has an internal thread and a second bonding surface,
the manufacturing method comprising:
a screwing step of screwing the external thread into the internal thread; and
an irradiation step of irradiating the first bonding surface and the second bonding surface with laser to bond the first bonding surface to the second bonding surface by laser welding and irradiating the external thread and the internal thread with laser to bond the external thread to the internal thread by the laser welding, after the screwing step.

25. The manufacturing method of the gas container according to claim 24, wherein the screwing step is performed by screwing the external thread into the internal thread until the first bonding surface comes into contact with the second bonding surface, and
the irradiation step is performed by bonding the first and second bonding surfaces brought into contact with each other by the laser welding.

26. The manufacturing method of the gas container according to claim 25, wherein the irradiation step is performed by bonding the first bonding surface to the second bonding surface and bonding the external thread to the internal thread in the circumferential direction by the laser welding.

27. The manufacturing method of the gas container according to claim 25, further comprising, prior to the screwing step, a step of making one of the first and second end portions by a laser transmitting resin, and making the other end portion of the first and second end portions by a laser absorbing resin,
the irradiation step being performed by irradiating the laser absorbing other end portion of the first and second end portions with the laser from the side of the one laser transmitting end portion of the first and second end portions.

28. The manufacturing method of the gas container according to claim 24, further comprising, prior to the screwing step, a step of providing the external thread of a metal material at the first liner constituting member by insertion molding and providing the internal thread of the metal material at the second liner constituting member by the insertion molding.

29. The manufacturing method of the gas container according to claim 24, wherein the irradiation step includes irradiating the screwed first and second liner constituting members with laser while rotating the liner constituting members in such a direction as to tighten the threads.

30. A bonding method of two members for bonding end portions of a pair of resin members having cylindrical end portions to each other by laser welding, the method comprising:
a step of screwing an external thread into an internal thread to temporarily bond the end portions to each other; and
a step of performing laser welding while rotating the pair of temporarily bonded resin members in such a direction as to tighten the threads.

31. A manufacturing method of a gas container having a resin liner, the resin liner including a first liner constituting member having at least a substantially cylindrical first end portion and a second liner constituting member having at least a substantially cylindrical second end portion,
wherein the first end portion has an external thread and a first bonding surface, and the second end portion has an internal thread and a second bonding surface,
the manufacturing method comprising:
a screwing step of screwing the external thread into the internal thread; and
an irradiation step of irradiating the screwed first and second liner constituting members with laser while rotating the liner constituting members in such a direction as to tighten the threads to bond the first bonding surface to the second bonding surface by laser welding.
